(19) United States
(12) Patent Application Publication
(10) Pub. No.: US 2007/0193972 A1
(43) Pub. Date: Aug. 23, 2007

(54) Hinged gantry crane

(76) Inventor: Xiaodong Huang, Hangzhou (CN)

Correspondence Address: KENYON & KENYON LLP, ONE BROADWAY, NEW YORK, NY, 10004, US

(21) Appl. No.: 11/581,101

(22) Filed: Oct. 13, 2006

(30) Foreign Application Priority Data
Oct. 14, 2005 (CN) 200510061114.8
Oct. 14, 2005 (CN) ZL200520015567.2

(51) Int. Cl. B66C 13/06

(52) U.S. Cl. 212/272

(57) ABSTRACT

A gantry crane comprising a bridge communicating with a trolley. The two ends of the bridge are connected to a main column whose lower end is connected to rollers. Various hinged joints allow for movement of the components towards and away from each other which allows the crane to be assembled or disassembled without the need for elevated or hoisted operations.

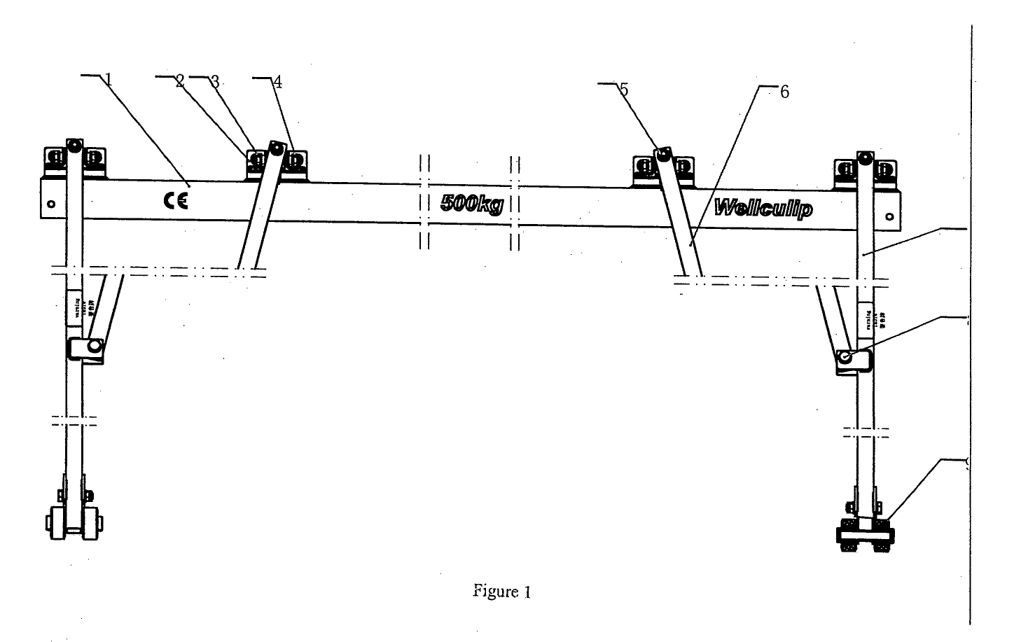

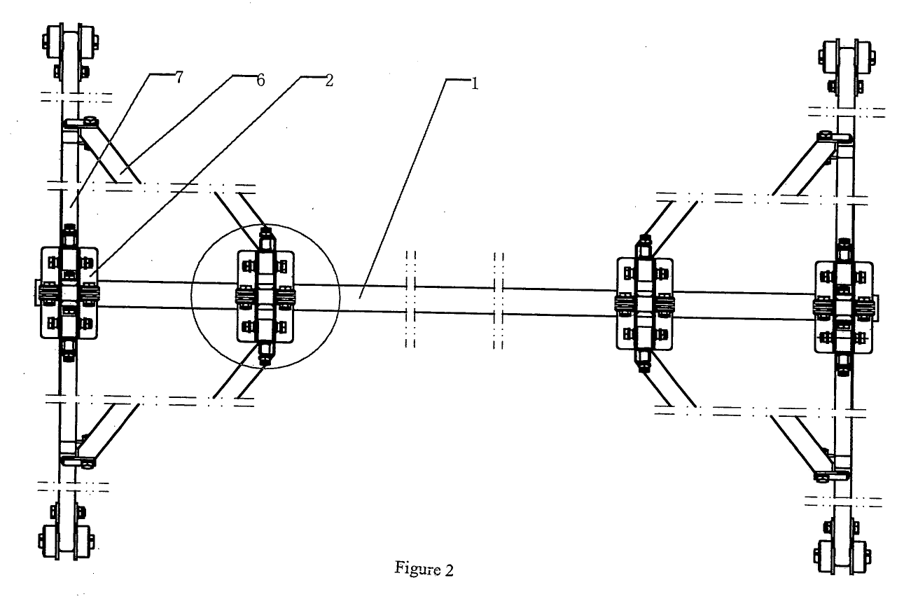

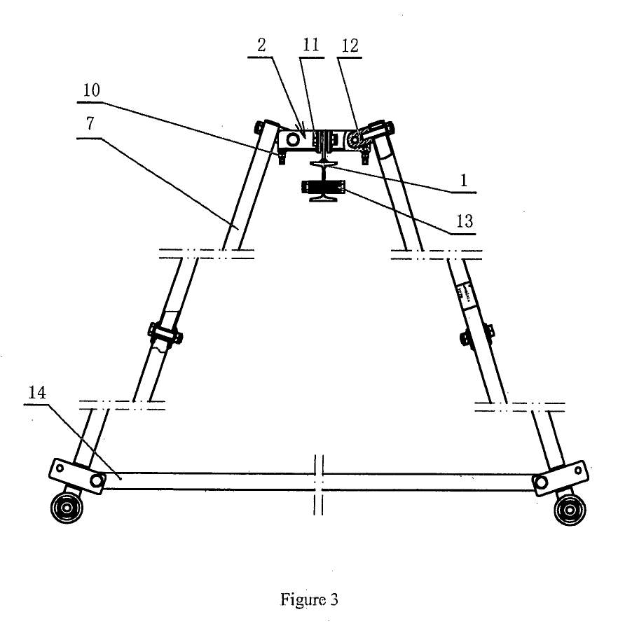

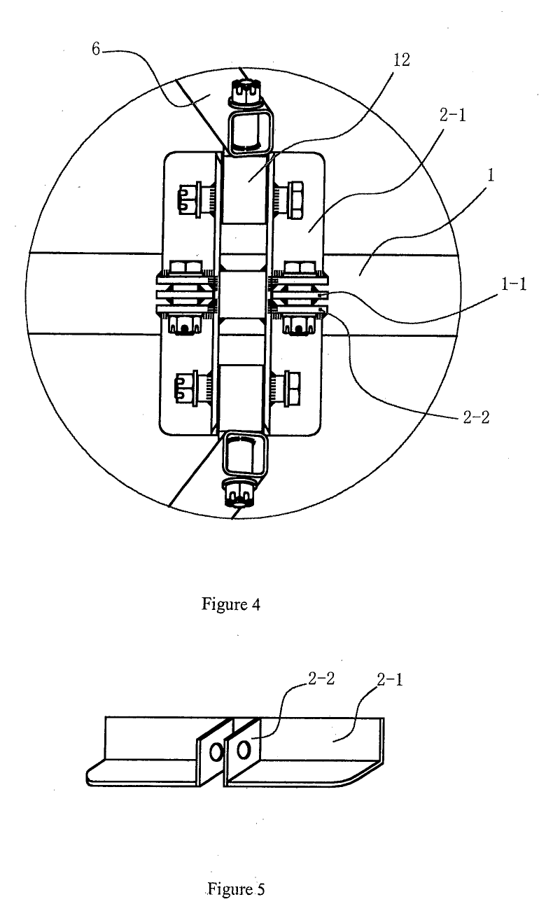

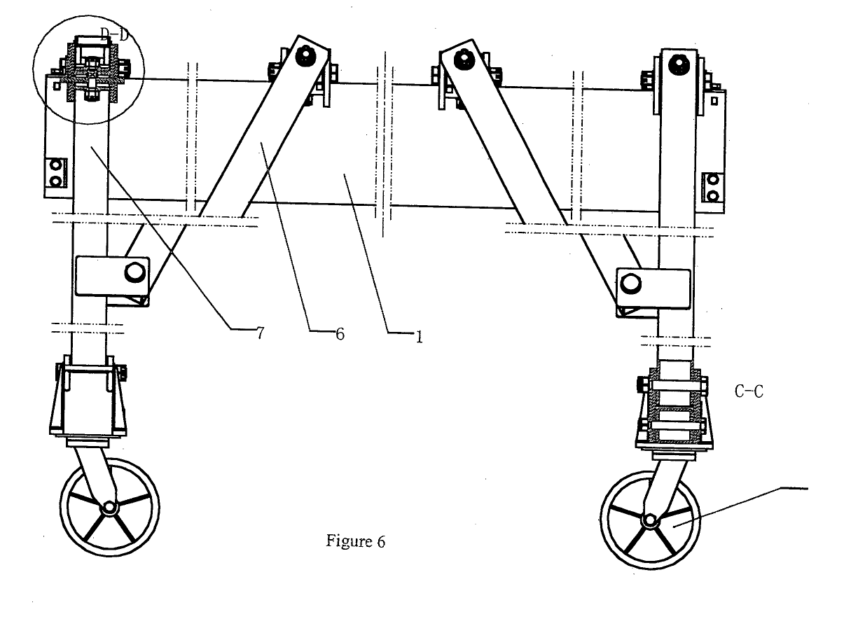

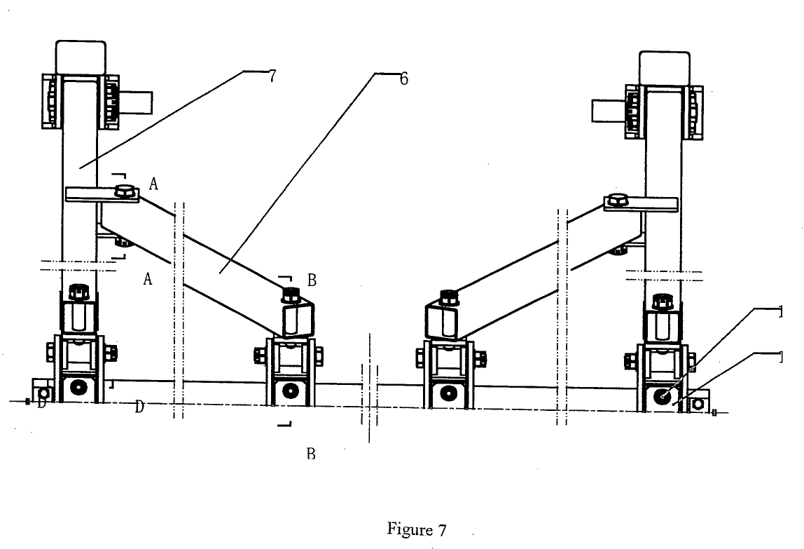

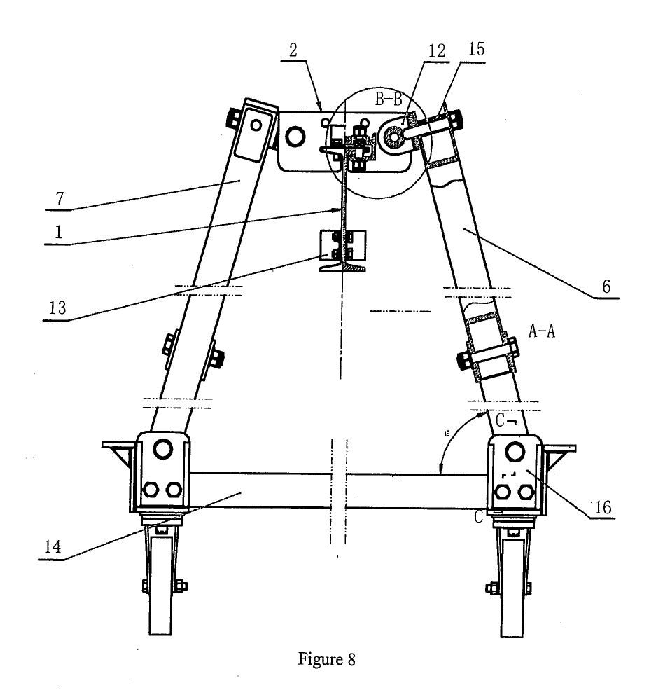

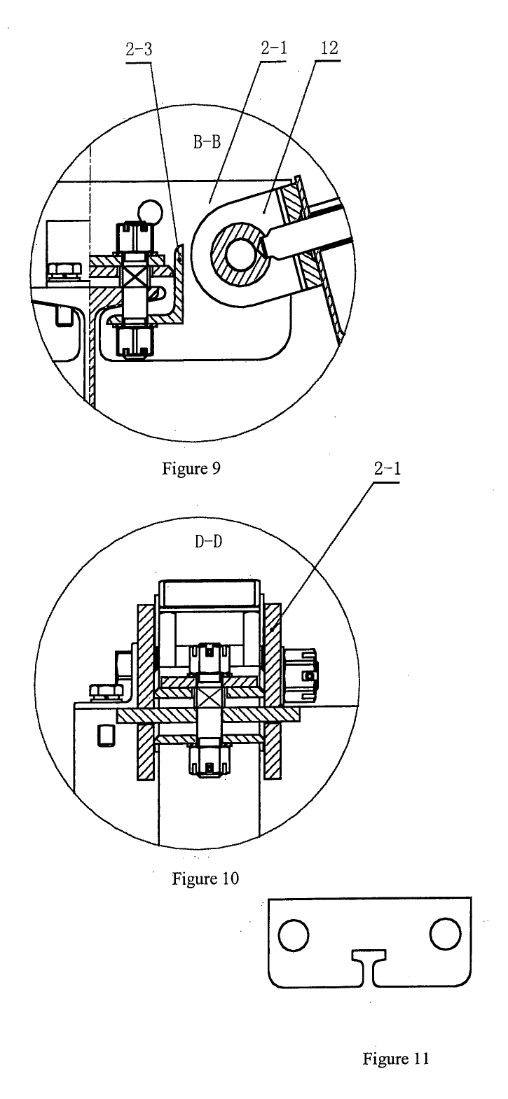

### TECHNICAL FIELD

This invention involves cranes, in particular cranes equipped with trolleys that may move about on a movable gantry frame.

### BACKGROUND TECHNOLOGY

Gantry cranes are composed of the bridge, the columns that are connected to the two ends of the bridge, the trolley on the bridge, and the manually operated or electrically operated load block. Due to structural reasons, existing gantry cranes are relatively tedious to assemble and dissemble; for example, the erection of the columns and the setting of the bridge both require high hoist operations, and the same for disassembly. This not only increases the work volume in assembly and disassembly, but also increases the amount of equipment used, and also impacts safety.

In an ideal situation, it would be possible to assemble and disassemble such cranes on the ground surface, without the need for hoisting and elevated operations, which will be safe and time-saving.

### DETAILS OF THE INVENTION

This invention intends to solve the problem in existing gantry cranes in that their assembly and disassembly are tedious and time consuming, and that assembly and disassembly cannot be conducted on the ground surface. A type of gantry crane is provided for this reason, which can be assembled and disassembled on the ground surface, without the need for elevated and hoisted operations.

In order to resolve the issues described above, the technical solution utilized by this invention is that it is equipped with a bridge and the trolley emplaced thereupon, the two sides of the two ends of the bridge are each connected to a main column, upon which the supporting columns are connected, the upper ends of which are connected to the bridge, the lower end of the main posts are connected to rollers, the base columns are connected to the bottoms of the main columns connected to the two sides of the two ends of the bridge, the characteristics of which being that: the shoulder joints are connected on the bridge, the cross joints are attached to the top ends of the main columns and supporting columns; a main column being connected to each of the two sides of the two ends of the bridge as described refers to: the cross joints hinged to the tops of the main columns described are hinged to the shoulder joints; the upper ends of which supporting columns are connected to the bridge as described above refers to: the cross joints hinged to the tops of the supporting columns as described above are hinged to the shoulder joints.

That the shoulder joints are linked to the bridge described refers to: each of the two ends of the bridge is linked to a shoulder joint, and there is a joint in each of the two places extending from each of the two ends of the bridge towards the center for a distance. The shoulder joints described are composed of two shoulder joint sections including those parallel to each other and crossing the bridge at 90°; that the cross joints hinged to the tops of the main columns are hinged to the shoulder joints refers to where said cross joints are hinged to places between the two shoulder joint sections of the shoulder joints linked to the two ends of the bridge, and that the cross joints hinged to the tops of the supporting columns are hinged to the shoulder joints refers to where the cross joints are hinged to the two shoulder joint sections on each of the two shoulder joints linked to places extending for a certain distance from the ends of the bridge towards the center of the bridge.

That shoulder joints are connected to the bridge described refers to where connector plates are linked to the topside of the bridge, and where shoulder joints are connected to the connector plates.

That shoulder joints are connected to the bridge described refers to where the shoulder joints are fitted over the bridge.

That the undersides of the main columns are fitted with rollers refers to where ankle joints are linked to the undersides of the main columns, on the undersides of which are fitted rollers.

Hinged as described in this invention may refer to hinging through a combination of threaded bolts and nuts. The hinging of the main columns, support columns, and the cross joints described, and the hinging of the cross joints and the shoulder joints as described, are connected through combining and tightening of threaded bolts and nuts. Since the main columns are sufficiently long, the force applied at an opposing or contrasting direction can create large torque, causing the point of connection between the cross joint and the shoulder joint to pivot with the connecting bolt at this location as the rotating axis, causing the bottoms of the main columns on the two sides of one end of the bridge to move closer to or further from each other, and similarly for the main columns on the two sides of the other end of the bridge; in fact, due to the combination of the threaded bolts and nuts, tightening will be mirrored, and where mirrored loosening is concerned, pivoting may be produced when there is sufficient torque, and under these conditions, it can be ensured that the structural stability and components of this invention will not be damaged. The supporting columns in this invention are always maintained on the same plane as the main columns, which refers to the plane on which the two main columns on the same end of the bridge are located. The bottoms of the supporting columns are connected to the main columns, and the tops of the supporting columns are connected to the shoulder joints through the cross joint; as the bottoms of the main columns on the two sides of one end of the bridge move closer to or further apart from each other, the supporting columns will move along with the main columns, since the tops of the supporting columns are linked to the shoulder joints through the cross joints, and its pivoting movement is similar to that of the main columns. Due to the ability to create this pivoting action, i.e. that the bottoms of the main columns on the two sides of one end of the bridge moving closer to or further apart from each other can be accomplished, this invention can be assembled or disassembled on the ground surface.

When assembling, the bridge can be placed on two holding plates or holding frames, causing such to be at a certain distance above the ground, then attaching the shoulder joints to the bridge, and attaching the cross joints to the shoulder joints, and attaching the main columns and supporting columns to the cross joints, connecting the bottoms of the supporting columns to the main columns, and attaching rollers to the bottoms of the main columns. Since the bridge is at a certain distance above the ground, the main columns on the two sides of one end of the bridge will be at an angle rather than on a straight line with those on the other end. As the bottoms of the two main columns on the two sides of the bridge are simultaneously pulled closer together by tractors or manually operated pulley assemblies, the tops of the upper columns will rise together with the bridge. Once a certain height has been reached, the bottom columns described are installed on the bottoms of the main columns on the two ends of the bridge. Disassembly can be conducted in reverse.

In addition, this invention can also take the form of folded assembly components, in order to facilitate storage, transportation, and subsequent assembly. Once the bottoms of the supporting columns are removed from the main columns, the bottoms of the main columns can be brought towards each other and further towards the bridge, and similarly for the supporting columns, causing the bridge, main columns, and the supporting columns to together form folded assembly components.

The bridge, main columns, supporting columns, shoulder joints, and cross joints in this invention can all be removed individually, forming independent components, and can be installed individually or in combination as pertinent.

Because the cross joints are hinged to the tops of the main columns and supporting columns, and the cross joints are hinged to the shoulder joints linked to the bridge, this invention can be assembled on the ground surface, and, once the assembly of the pertinent parts and components have been completed, installing the bottom column after the required [height] has been achieved through pulling the bottoms of the main columns on the two ends of the bridge and causing such to draw together, to complete the assembly and setup of this invention. It is feasible to keep the bridge horizontal while pulling on the main columns on the two sides of the two ends of the bridge, such as to prevent the monorail trolley from sliding. Disassembly of this invention can be conducted in reverse, completing the disassembly on the ground surface. This invention can be assembled and disassembled on the ground surface, without the need for hoisting and elevated operations, and it is safe, convenient, and time-saving.

### DESCRIPTIONS OF ATTACHED DRAWINGS

Drawing 1 is a structural diagram of an implementation of this invention;

Drawing 2 is a top view drawing of Drawing 1;

Drawing 3 is the left view drawing of Drawing 1;

Drawing 4 is an enlarged partial drawing of Drawing 2 including the shoulder joints;

Drawing 5 is a diagram of the shoulder joint component in Drawing 4;

Drawing 6 is the structural diagram of another implementation of this invention;

Drawing 7 is a top view drawing of Drawing 6;

Drawing 8 is the left view drawing of Drawing 6;

Drawing 9 is an enlarged partial drawing of Drawing 8 including the shoulder joints and cross joints;

Drawing 10 is an enlarged partial drawing of Drawing 6 including the shoulder joints;

Drawing 11 is a diagram of the shoulder joint component in Drawing 9.

The legend in the drawings are: 1 Bridge, 1-1 Connector Plate, 2 Shoulder Joint, 2-1 Shoulder joint component, 2-2 Supporting Plate, 2-3 Connector, 3 Nut, 4 Bolt, 5 Spring Type Pin, 6 Supporting Column, 7 Main Column, 8 Bolt, 9 Roller, 10 Bolt, 11 Nut, 12 Cross Joint, 13 Stopper, 14 Bottom Column, 15 Support Sleeve, 16 Ankle Joint, 17 Double sided bolt, 18 Cover Plate,

### EXAMPLE OF AN IMPLEMENTATION 1

For this example of the gantry crane, see Drawing 1-Drawing 5, bridge with H beam 1, on which is emplaced a trolley, from the underside of which is suspended a pulley assembly for hauling, and the two ends of the bridge equipped with stoppers 13; connector plates 1-1 are linked to the tops of the two ends of the bridge and the places extending from the two ends of the bridge towards the center, the shoulder joints 2 are linked to the connector plates 1-1, the shoulder joints 2 are composed of two shoulder joint components 2-1 using steel angles, the center of the lower section of the shoulder joint component is grooved and two supporting plates 2-2 bored through the center are welded to the sides of the groove, supporting plates 2-2 are connected to the connector plate 1-1 through a combination of threaded bolts and nuts; cross joints 12 are linked to the shoulder joints 2 through a combination of bolts 4 and nuts 3 and locked in place with spring type pin, the outer end of the cross joint 12 is threaded and connected to main columns 7 and supporting columns 6 in combination with nuts, and locked in place with spring type pin 5, the bottoms of the supporting columns 6 are linked to the supporting plates installed on the main columns through a combination of bolts (8) and nuts; rollers 9 are linked to the bottoms of the main columns; and the bottom columns 14 are linked to the bottoms of the main columns on the two sides of one end and the other end of the bridge.

### AN EXAMPLE OF AN IMPLEMENTATION 2

For this example of the gantry crane, see Drawing 6-Drawing 11, bridge with H beam 1, on the upper wing edges of the bridge are installed shoulder joints 2, shoulder joints 2 are formed by welding the two shoulder joint components 2-1 which are grooved on the underside and bored on the two ends through the connector using steel angles, across the top of which connectors 2-3 the cover plate 18 is linked, equipped with double-sided bold 17 that passes through the connector 2-3, the upper wing edges of the bridge, and the cover plate 18, and fastened in combination with the nuts; the cross joints 12 are linked on the shoulder joints through the combination of bolts and nuts, and the main columns 7 and supporting columns 6 are linked to the outer ends of the cross joints through bolts and support sheaths 15, ankle joints 16 are linked to the bottoms of the main columns with four faced compound plates through a combination of bolts and nuts, and rollers 9 are linked to the bottoms of the ankle joints; the remainder of the structure is the same as that for the above example. The gantry crane in this example is suitable for hoisting objects of greater weight as compared to example 1.

1. Gantry crane equipped with a bridge (1) and the trolley emplaced thereupon, the two sides of the two ends of the bridge (1) are each connected to a main column (7), upon which the supporting columns (6) are connected, the upper ends of which are connected to the bridge (1), the lower end of the main posts (7) are connected to rollers (9), the base columns (14) are connected to the bottoms of the main columns connected to the two sides of the two ends of the bridge, the characteristics of which being that: the shoulder joints (2) are connected on the bridge (1), the cross joints (12) are attached to the top ends of the main columns (7) and supporting columns (6); a main column being connected to each of the two sides of the two ends of the bridge as described refers to: the cross joints (12) hinged to the tops of the main columns described are hinged to the shoulder joints (2); the upper ends of which supporting columns are connected to the bridge as described above refers to: the cross joints (12) hinged to the tops of the supporting columns as described above are hinged to the shoulder joints (2).

2. The gantry crane as described in claim 1, the characteristics of which being that the shoulder joints (2) are linked to the bridge described (1) refers to: each of the two ends of the bridge is linked to a shoulder joint, and there is a joint in each of the two places extending from each of the two ends of the bridge towards the center for a distance. The shoulder joints described are composed of two shoulder joint sections (2-1) including those parallel to each other and crossing the bridge at 90°; that the cross joints hinged to the tops of the main columns are hinged to the shoulder joints refers to where said cross joints are hinged to places between the two shoulder joint sections of the shoulder joints linked to the two ends of the bridge, and that the cross joints hinged to the tops of the supporting columns are hinged to the shoulder joints refers to where the cross joints are hinged to the two shoulder joint sections on each of the two shoulder joints linked to places extending for a certain distance, from the ends of the bridge towards the center of the bridge.

3. The gantry crane as described in claims 1 or 2, that the characteristics of which being that shoulder joints (2) are connected to the bridge (1) described refers to where connector plates (1-1) are linked to the topside of the bridge, and where shoulder joints are connected to the connector plates.

4. The gantry crane as described in claims 1 or 2, that the characteristics of which being that shoulder joints (2) are connected to the bridge (1) described refers to where the shoulder joints are fitted over the bridge.

5. The gantry crane as described in claim 4, that the characteristics of which being that the undersides of the main columns (7) are fitted with rollers (9) refers to where ankle joints (16) are linked to the undersides of the main columns, the undersides of which are fitted rollers.
